(19) United States
(12) Patent Application Publication
(10) Pub. No.: US 2024/0123442 A1
(43) Pub. Date: Apr. 18, 2024

(54) Vitrification Device with Textured Surface for Sealing

(71) Applicant: Cook Medical Technologies LLC, Bloomington, IN (US)

(72) Inventors: Jorge L. Jimenez-Rios, Bloomington, IN (US); Victor Havill, Bloomington, IN (US); Donald R. Sandmore, Ellettsville, IN (US)

(73) Assignee: Cook Medical Technologies LLC, Bloomington, IN (US)

(21) Appl. No.: 18/485,495

(22) Filed: Oct. 12, 2023

Related U.S. Application Data
(60) Provisional application No. 63/416,119, filed on Oct. 14, 2022.

(51) Int. Cl. B01L 3/00

(52) U.S. Cl. CPC B01L 3/50; B01L 2200/0689

(57) ABSTRACT

A sealable container for preservation of a biological sample is provided. The sealable container includes a cap and an elongate body. The cap has a proximal open end and a distal end with a lumen extending from the proximal open end to the distal end. The elongate body extends from a handle portion to a specimen portion, where the specimen portion is configured to receive a biological sample thereon. The elongate body further includes a closure portion disposed between the handle portion and the specimen portion, where the closure portion is configured to make surface to surface contact with the cap when the specimen portion of the elongate body is fully inserted within the lumen of the cap. At least one of an inner surface of the cap and an outer surface of the elongate body includes a textured area with a textured surface finish.

### CROSS-REFERENCE TO RELATED APPLICATIONS

This application claims priority from U.S. Provisional Application No. 63/416,119, filed Oct. 14, 2022, which is hereby fully incorporated by reference herein in its entirety.

### BACKGROUND

The device described in this specification relates to devices provided for retaining a biological sample for long term cryopreservation within a cryocontainer. The device may be used for vitrification, specifically vitrification of embryos or oocytes or other biological material, such as in conjunction with or in preparation for In Vitro Fertilization (IVF) cycles.

In the context of IVF, vitrification of embryos and oocytes has been replacing conventional cryopreservation for the past decade. The vitrification procedure is performed to store unused embryos after undergoing an IVF cycle, to temporarily store embryos while genetic analysis is performed, and as a method of oocyte preservation for female fertility preservation. The technique itself uses high concentrations of cryoprotectant agents and fast cooling rates to completely avoid ice formation.

As the specimens are stored long-term submerged in liquid nitrogen, it is desirable to store them in devices that have the capability of providing a seal so that the specimen is isolated from the liquid nitrogen surrounding it. If liquid nitrogen leaks into the interface between the elongate body and the cap, when the device is taken out of the liquid nitrogen, the pressure created by the warming and concordant expansion of nitrogen in the cap may propel the cap off the elongate body. Alternatively, rather than isolating and hermetically-sealing the specimen away from the nitrogen, it may be desirable to provide a seal that is effective to protect the specimen, and that also allows venting of any trapped nitrogen and/or other material between the cap and the elongate body.

### BRIEF SUMMARY

One general aspect of the present disclosure includes a sealable container for preservation of a biological sample, including a cap having a proximal open end and a distal end with a lumen extending from the proximal open end to the distal end; and an elongate body that extends from a handle portion to a specimen portion, where the specimen portion is configured to receive a biological sample thereon, the elongate body further including a closure portion disposed between the handle portion and the specimen portion, where the closure portion is configured to make surface to surface contact with the cap when the specimen portion of the elongate body is fully inserted within the lumen of the cap, where at least one of an inner surface of the cap that will contact the closure portion when engaged thereto and an outer surface of the closure portion that will contact the cap when engaged thereto includes a textured area with a textured surface finish.

Another general aspect of the present disclosure includes a sealable container for preservation of a biological sample, including a cap having a proximal open end and a distal end with a lumen extending from the proximal open end to the distal end; and an elongate body that extends from a handle portion to a specimen portion, where the specimen portion is configured to receive a biological sample thereon, the elongate body further including a closure portion disposed between the handle portion and the specimen portion, where the closure portion is configured to make surface to surface contact with the cap when the specimen portion of the elongate body is fully inserted within the lumen of the cap, where an inner surface of the cap that will contact the closure portion when engaged thereto and an outer surface of the closure portion that will contact the cap when engaged thereto each include a textured area with a textured surface finish.

Another general aspect of the present disclosure includes a sealable container for preservation of a biological sample, including a cap having a proximal open end and a distal end with a lumen extending from the proximal open end to the distal end; and an elongate body that extends from a handle portion to a specimen portion, where the specimen portion is configured to receive a biological sample thereon, the elongate body further including a closure portion disposed between the handle portion and the specimen portion, where the closure portion is configured to make surface to surface contact with the cap when the specimen portion of the elongate body is fully inserted within the lumen of the cap, where an outer surface of the closure portion that will contact the cap when engaged thereto includes a textured area with a textured surface finish.

A sealable container according to the present disclosure may include any combination of the features described above and/or the original as-filed claims.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a cryopreservation device, including an elongate member and a cap.

FIG. 2 is a side view of the elongate member of FIG. 1.

FIG. 3 is a top view of the elongate member of FIG. 1.

FIG. 4 is a side view of detail A of FIG. 2.

FIG. 5 is a top view of detail A of FIG. 2.

FIG. 6 is a cross-sectional view of the section Z-Z of FIG. 5.

FIG. 7 is a view of six cryopreservation devices aligned within a sleeve of a cryocontainer.

FIG. 8 is a perspective view of the cap of the cryopreservation device of FIG. 1.

FIG. 9 is a side cross-sectional view of the cap of FIG. 8.

FIG. 10 is a cross-sectional view of the elongate member of FIG. 1 along section T-T when the specimen portion of the elongate member is fully inserted within the cap.

FIG. 11 is a cross-sectional view of the elongate member of FIG. 1 along section T-T.

FIG. 12 is an enlarged side view of a portion of the elongate member of FIG. 1, showing a closure portion with a textured surface finish.

FIG. 13 is an enlarged cross-sectional view of a portion of the cap of FIG. 8, showing an inner surface of the cap with a textured surface finish.

FIG. 14 is an enlarged side view of a portion of the elongate member of FIG. 1, showing a portion of a closure portion with a textured surface finish.

FIG. 15 is an enlarged cross-sectional view of a portion of the cap of FIG. 8, showing a portion of an inner surface of the cap with a textured surface finish.

### DETAILED DESCRIPTION OF THE DRAWINGS AND THE PRESENTLY PREFERRED EMBODIMENTS

Various embodiments are described below with reference to the drawings in which like elements generally are referred to by like numerals. The relationship and functioning of the various elements of the embodiments may better be understood by reference to the following detailed description. However, embodiments are not limited to those illustrated in the drawings. It should be understood that the drawings are not necessarily to scale (although drawings to scale will be identified as such, and may be relied upon for this purpose), and in certain instances details may have been omitted that are not necessary for an understanding of embodiments disclosed herein, such as—for example—conventional fabrication and assembly.

The invention is defined by the claims, may be embodied in many different forms, and should not be construed as limited to the embodiments set forth herein; rather, these embodiments are provided so that this disclosure will be thorough and complete, and will fully convey enabling disclosure to those skilled in the art. As used in this specification and the claims, the singular forms “a,” “an,” and “the” include plural referents unless the context clearly dictates otherwise. Reference herein to any industry standards (e.g., ASTM, ANSI, IEEE standards) is defined as complying with the currently published standards as of the original filing date of this disclosure concerning the units, measurements, and testing criteria communicated by those standards unless expressly otherwise defined herein.

The terms “proximal” and “distal” are used herein in the common usage sense where they refer respectively to a handle/doctor-end of a device or related object and an opposite end of a device or related object. The terms “about,” “approximately,” “substantially,” “generally,” and other terms of degree, when used with reference to any volume, dimension, proportion, or other quantitative or qualitative value, are intended to communicate a definite and identifiable value within the standard parameters that would be understood by one of skill in the art (equivalent to a medical device engineer with experience in this field), and should be interpreted to include at least any legal equivalents, minor but functionally-insignificant variants, standard manufacturing tolerances, and including at least mathematically significant figures (although not required to be as broad as the largest range thereof).

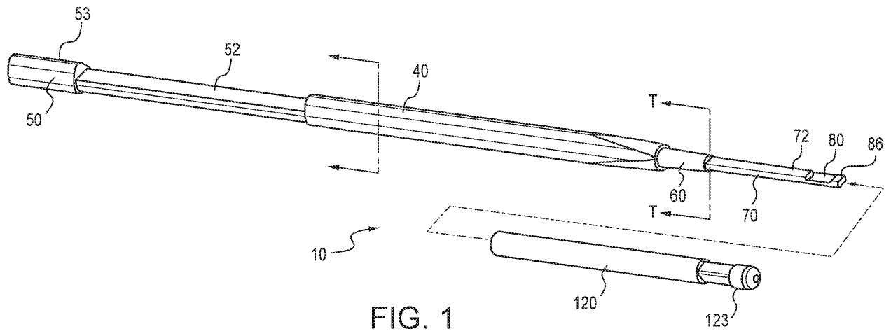

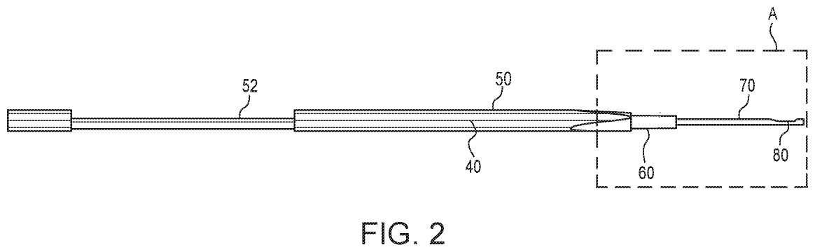

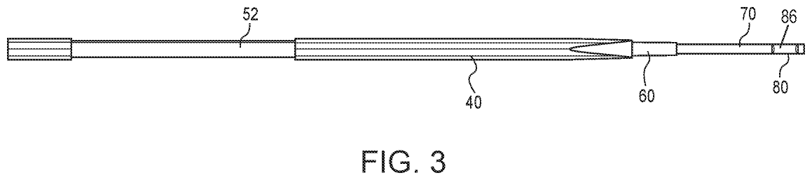

Turning now to FIGS. 1-15 a device 10 for receiving and storing material for cryopreservation is provided. The device 10 may be a sealable container that is configured for receipt of a biological sample, which encloses and supports the biological sample for long term receipt within a cryopreservation container, such as a dewar. The device 10 may sealably retain the biological sample with various structures as described herein.

As shown in FIGS. 1-11, and as described in greater detail below, the cap 120 may be placed over the specimen portion 70, and through a press fit between the cap 120 and a portion of the elongate body 40 (e.g., the closure portion 60), a seal against liquid nitrogen ingress is created. This seal needs to be created in room temperature, maintained in liquid nitrogen (−196° C.), and maintained when the device is brought back to room temperature until removal by the user. Creating such a seal is critical. Specifically, for example, when the closure portion 60 is inserted into the cap 120, in the room temperature and pressure, at the location where they contact each other, the taper of the closure portion 60 will force the cap 120 to deform to create an interference fit therebetween. Then the device 10 (along with the cap 120) is inserted into liquid nitrogen (−196° C.). By the action of the cap 120 contracting at lower temperatures, it creates a seal around the location of the interference fit, so that liquid nitrogen will not leak into the device 10. If liquid nitrogen leaks into the interface between the closure portion 60 and the cap 120, when the device 10 is taken out of the liquid nitrogen, the pressure created by the nitrogen in the cap 120 may propel the cap 120 off the elongate body 40. In addition, the leaking of liquid nitrogen may contaminate the specimen (e.g., embryos, oocytes) on the specimen portion 70.

The seal against liquid nitrogen entry may be improved when the surfaces at interference between the cap 120 and the elongate body 40 have a textured, instead of a high polish, surface finish. Improvement of this seal against direct contact with liquid nitrogen may keep specimens safe from potential contamination, such that the performance of a closed vitrification may be improved. Applicant is not aware of any product from competitors that actually creates such a hermetic seal, let alone the improved seal performance achieved by the invention in the present application.

Various levels of textured surface finish may be provided. In some embodiments, the average surface roughness (Ra value) of the textured areas 205 may range from an Ra value of about 1 pin through about 28 pin (which corresponds to approximately Grade #6 Diamond Buff Polish to approximately 400 Grit Stone Polish), preferably from an Ra value of about 2 pin through about 25 pin, and more preferably from an Ra value of about 4 pin through about 5 pin (which corresponds to approximately 400 Grit Paper Polish). As one non-limiting example, the Ra value of the textured area 205 on the inner surface 202 of the cap 120 may range from an Ra value of about 4 pin through about 5 pin, and the Ra value of the textured area 205 on the outer surface 204 of the closure portion 60 may range from an Ra value of about 25 pin through about 28 pin (which corresponds to approximately 400 Grit Stone Polish). In some embodiments, at least one of the cap 120 and the elongate body 40 may be made from material comprising a styrene-acrylic co-polymer. For example, materials used for the cap 120 and/or the elongate body 40 may include Zylar® 960 and/or Methyl Methacrylate Butadiene Styrene (MBS).

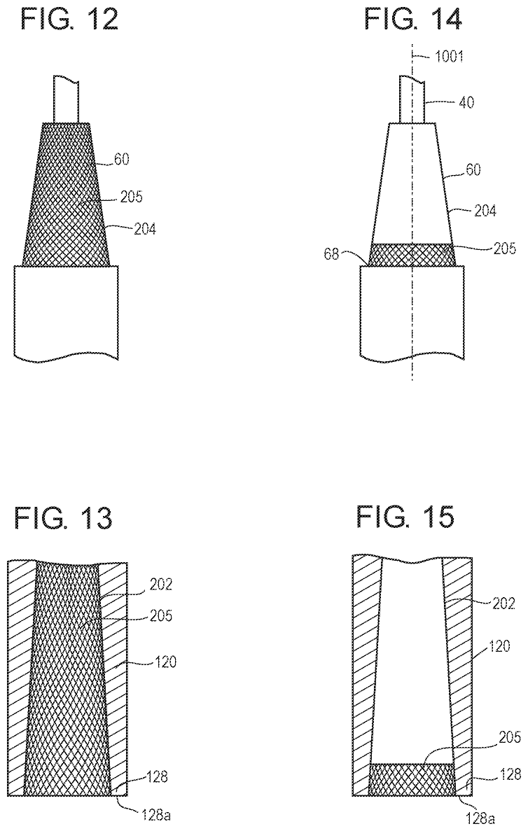

Various configurations (e.g., length, size, shape) of the textured surface(s) on the outer surface 204 of the closure portion 60 and/or on the inner surface 202 of the cap 120 may be provided. In some embodiments, referring to FIGS. 12-15, at least one of the inner surface 202 of the cap 120 (e.g., that will contact the elongate body when engaged thereto) and the outer surface 204 of the elongate body 40 (e.g., that will contact the cap when engaged thereto; closure portion 60) may include a textured area with a textured surface finish to improve the performance of the seal. The textured surface finish may be applied to either of these surfaces, or both. In some embodiments, if the textured surface is only present on one of these surfaces, the preferred textured surface would be on the outer surface 204 of the elongate body 40.

The configuration (e.g., length, size, shape) of the textured area(s) 205 may be varied, as desired and/or needed, without departing from the scope of the present invention. The textured area 205 may cover at least a portion of the inner surface 202 of the cap 120, and/or at least a portion of the outer surface 204 of the elongate body 40 (e.g., the closure portion 60). As one non-limiting example, the textured area 205 may cover an entirety of the inner surface 202 of the cap 120. As another non-limiting example, the textured area 205 may cover an entirety of the outer surface 204 of the closure portion 60, or a portion of the entirety of both surfaces.

As another non-limiting example, as shown in FIGS. 14 and 15, the textured area 205 may cover a portion of the inner surface 202 of the cap 120, and/or a portion (e.g., about 50% or less) of the outer surface 204 of the closure portion 60 (e.g., the textured area 205 forms a ring section that has a length about 1-6 mm along the longitudinal axis 1001 of the elongate body 40). It will be appreciated that the textured area(s) 205 extending around at least a portion of the circumference of the outer surface 204 of the closure portion 60 and/or the inner surface 202 of the cap 120 may be discontinuous or continuous/complete, as desired and/or needed, to achieve varying seal performance. That is to say that the entire surface area, or less than the entire surface area of the inner cap surface and/or the outer closure portion surface may be textured, with preferred embodiments providing a connective seal or other attachment that is superior to prior similar engaging surfaces and that effectively prevents inadvertent or spontaneous release of the cap. The term “about” as used herein with respect to a dimension (e.g., length, width, height, depth) or roughness (e.g., Ra value, as used below) is defined to include the specific value referenced as well as a value that is within 5% of the value both above and below the referenced value.

As a non-limiting example, in some embodiments, the textured area(s) 205 on the outer surface 204 of the closure portion 60 and/or on the inner surface 202 of the cap 120 may be greater than or substantially equal to the area of contact or engagement between the closure portion 60 and the cap 120. In some embodiments, it is possible that a user may not push the cap 120 all the way down the taper of the closure portion 60, so that only a portion of the textured area 205 on the outer surface 204 of the closure portion 60 contacts the inner surface 202 of the cap 120. As a non-limiting example, the total area of the outer surface 204 of the closure portion 60 may be about 43.3 mm², and the sealing may occur in about the first 2 mm of the cap opening, which may translate to about 10-14 mm² of contact area between the closure portion 60 and the cap 120.

In some embodiments, the textured area 205 on the inner surface 202 of the cap 120 may extend along a length to a position at about 3-10 mm from the edge 128a of the open proximal end 128 of the cap 120, and/or the textured area 205 on the outer surface 204 of the closure portion 60 may extend along a length of the closure portion 60 to a position at about 3-10 mm from the proximal end 68 of the closure portion 60. In these embodiments, the Ra value of at least one of the textured area(s) 205 may vary from about 4 pin to about 5 pin, being equivalent to approximately 400 Grit Paper Polish.

Higher, more aggressive textures, such as with an Ra value higher than about 10 pin, or equivalent to approximately 600 stone finish, may prove challenging to manufacture consistently, thus a smaller region of the inner surface 202 of the cap 120 and/or the outer surface 204 of the closure portion 60 may be textured, such as extending to a position between about 1-3 mm from the edge 128a of the open proximal end 128 of the cap 120 and/or from the proximal end 68 of the closure portion 60. For less aggressive textures, such as between about 4-5 pin, or equivalent to approximately 400 grit paper finish, the length of the textured area can be longer, such as extending to a position between about 6-10 mm, and more preferably between about 6-7 mm from the edge 128a of the open proximal end 128 of the cap 120 and/or from the proximal end 68 of the closure portion 60.

It will be appreciated that the textured area 205 may or may not begin precisely at or abut the proximal end 68 of the closure portion 60 and/or the edge 128a of the open proximal end 128 of the cap 120 (e.g., due to manufacturing tolerances). In addition, it will be appreciated that the textured area 205 may or may not have the same height (as measured along the longitudinal axis) around the circumference of the closure portion 60 and/or the lumen 132 of the cap 120.

It should be understood that roughness/smoothness values provided herein are described in keeping with standard values. Namely, as described in ASME B46.1 (published 2020), Ra is the arithmetic average of the absolute values of the profile height deviations from the mean line, recorded within the evaluation length. Simply put, Ra is the average of a set of individual measurements of a surface's peaks and valleys measured from a centerline mean of those values. This roughness average value (Ra) may be expressed in micro inches (pin). Alternatively, smoothness/roughness may be expressed as an SPI value or finishing method, where SPI refers to the surface finish standard set by SPI (Society of the Plastics Industry). The standard covers twelve SPI grades of polish finishes: SPI A1 to SPI D3 (RA 0 pin to Ra 230 pin) as published and known in the polymer surface finishing industry at the time of filing of the present patent application, where SPI A1 corresponds to approximately Grade #3 Diamond Buff Finish, and SPI D3 corresponds to approximately Dry Blast Finish with #24 Oxide.

The device 10 may include a cap 120 and an elongate body 40, wherein a portion of the elongate body 40 is inserted and extends within a lumen 132 of the cap 120. As discussed below, the elongate body has a closure portion 60 that is configured to engage the lumen 132 of the cap 120 when a specimen portion 70 of the elongate body 40 is fully inserted within the lumen 132.

The elongate body 40 is best shown in FIGS. 1-5. The elongate body 40 extends from a handle portion 50 to a specimen portion 70. The handle portion 50 is configured to be manipulated by the user, such as to insert and remove the device 10 from the cryocontainer 800 (FIG. 7). The handle portion 50 also is adapted to include biographical information about the biological specimen stored within the device 10, as discussed below. The specimen portion 70 is configured to receive and support a biological sample thereon, as can be understood, the biological sample is disposed and removed from the specimen portion 70 when uncovered, and the device 10 is configured for storage when the cap 120 is disposed upon the specimen portion 70 of the elongate body 40.

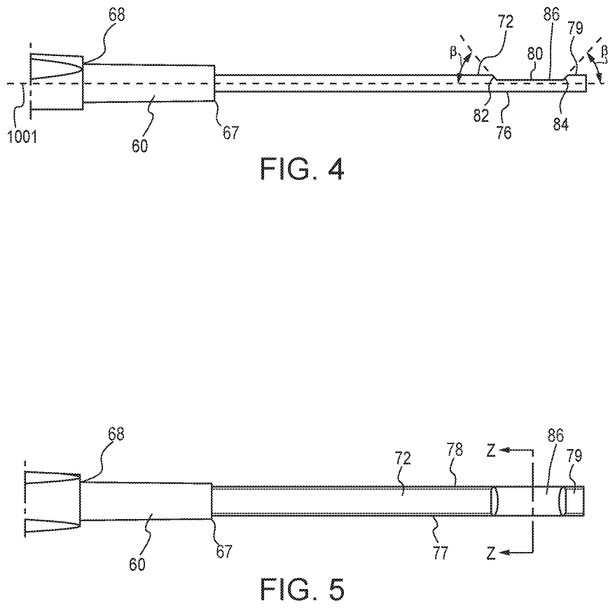

The specimen portion is best shown in FIGS. 4-5. The specimen portion 70 includes an upper surface 72 and a lower surface 76. In some embodiments, one or both the upper and lower surfaces 72, 76 are planar along at least a portion thereof. In other embodiments, one or both of the upper and lower surfaces may be arcuate. The specimen portion 70 additionally includes right and left surfaces 77, 78 that bridge between opposite edges or in some embodiments end portions of the respective upper and lower surfaces 72, 76. In some embodiments, the cross-section of the specimen portion (other than the one or more specimen portions—discussed in additional detail below) may be rectangular, square, circular, elliptical or other geometries. For example, the upper and lower surfaces 72, 76 may be planar while the right and left surfaces 77, 78 may be arcuate, or vice versa.

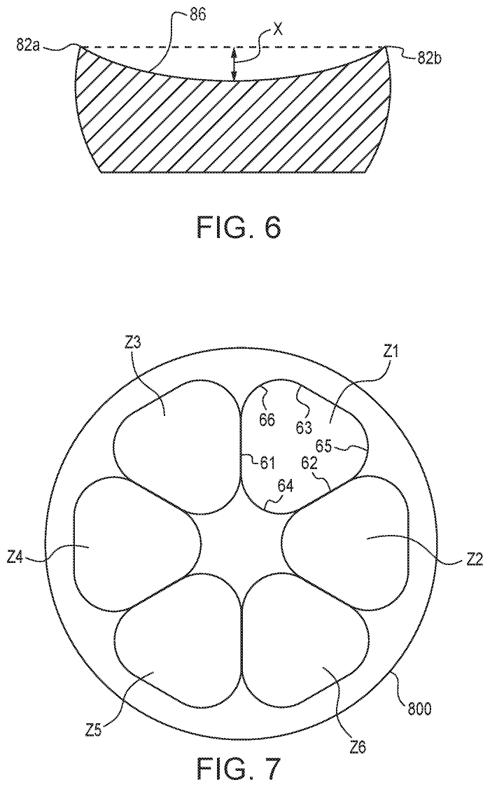

The scooped portion 80, may be a single portion, or multiple spaced scooped portions along the length of the specimen portion 70. The scooped portion 80 may be a location where the thickness of the specimen portion 70 (as measured between the upper and lower surfaces 72, 76) is less than a thickness of other positions along the specimen portion 70. In one representative embodiment of the disclosure, the thickness of the scooped portion is 0.35 mm less than the thickness of the specimen portion 70 bordering the scooped portion 80, in other words the depth of the scooped portion in this embodiment is 0.35 mm. In some embodiments, the depth of the scooped portion is greater than the largest outer diameter of the biological sample that is expected to be positioned upon the scooped portion 80 for storage within the device 10. The scooped portion 80 includes a surface 86 upon which a biological sample rests when placed thereon. In some embodiments, the surface may be as depicted in FIG. 6, where the surface 86 is arcuate, and in some embodiments concave. In one representative embodiment, the cross-section of the scooped portion has a central point that is 0.2 mm lower than the outside edges 82a, 82b of the scooped portion, as depicted by the dimension X on FIG. 6. In some embodiments, the surface 86 of the scooped portion may have a constant profile along its length, while in other embodiments, the shape of the surface 86 may change along its length, such as a centerline of the surface 86 (that runs parallel to the longitudinal axis 1001 of the elongate body 40) is arcuate and in some embodiments concave.

The scooped portion 80 may transition from the remainder of the specimen portion 70 with side walls 82, 84. The side walls may be planar (as shown in FIG. 4) while in other embodiments, side walls 82, 84 may be arcuate. In some embodiments, the side walls 82, 84 are perpendicular to the longitudinal axis 1001 of the elongate body 40, while in other embodiments, the side walls 82, 84 may extend an acute angle β with respect to longitudinal axis 1001. The angle β may be within a range of about 15 to about 75 degrees, or about 30 to 60 degrees or about 40 degrees to about 50 degrees. The word “about” as used herein when referencing an angle is defied to include the value referenced as well as plus or minus 2.5 degrees from the reference value. In some representative embodiments, the angle β may be 40, 45, 50, degrees or other angles that may be understood by one of ordinary skill in the art after a thorough review of the subject specification and figures. In some embodiments, first and second side walls 82, 84 may be the same geometry (although facing in opposite directions) or the side walls 82, 84 may be formed from differing geometry.

In some embodiments, the scooped portion 80 is positioned proximal from a distal tip 79 of the specimen portion. In these embodiments, the cross-sectional geometry of the distal tip 79 may be the same as the cross-sectional geometry of the specimen portion 70 proximal of the scooped portion 80, or in other embodiments, the cross-sectional geometry may be different, but also different from the scooped portion. In a representative embodiment, the scooped portion may be between about 4.0 to about 6.0 mm in length, inclusive of the bounds of this ratio.

As one of ordinary skill in the art will comprehend after a thorough review of the subject specification and figures, the size and dimensions of the different portions of the device 10 may vary based upon the expected size and type of the biological sample and the size of the cryocontainer.

The closure portion 60 is disposed between the handle portion 50 and the specimen portion 70. In some embodiments, the closure portion 60 includes a gradually increasing cross-sectional geometry along at least a portion of its length. The closure portion 60 is positioned along the specimen portion 70 such that at least a portion of the inner surface 202 of the cap 120 (discussed in further detail below) contacts/engages the closure portion 60 when the specimen portion 70 is fully inserted within the lumen 132 of the cap 120, where the contact/engagement portion may be less than an entire surface area of the cap and/or the closure portion. In some embodiments, the outer diameter of the closure portion 60 may be the same as the inner diameter of the lumen 132 of the cap 120 within at least a portion of the contact area between the closure portion 60 and the cap 120 when the specimen portion 70 is fully inserted within the cap 120. In other embodiments, the outer diameter of the closure portion 60 is slightly larger than the inner diameter of the lumen 132 of the cap 120 within at least a portion of the contact area between the closure portion 60 and the cap 120 when the specimen portion 70 is fully inserted. In this embodiment, the material that forms one or both of the cap 120 and the closure portion 60 may be sufficiently soft to slightly compress, which increases the strength of the connection between the cap and the closure portion.

As a non-limiting example, to form an interference fit between the closure portion 60 and the cap 120, the nominal outer diameter of the largest part of the closure portion 60 is about 0.05 mm larger than the nominal inner diameter of the largest part of the cap 120 (e.g., the lumen 132 of the cap 120). This diameter difference may be varied without departing from the scope of the present invention, for example, the difference may range from about 0.0 to 0.1 mm. Depending on the manufacturing tolerances and the diameter difference discussed above, the device 10 may be closed (with the cap 120 placed over at least a portion of the closure portion 60) a different amount, if the user assumes a same capping force.

It will be appreciated that a user may or may not push the cap 120 all the way down the taper of the closure portion 60. In some embodiments, the device 10 is configured to be capped (e.g., placing the cap 120 over at least a portion of the closure portion 60 to create a desired sealing therebetween) and uncapped (e.g., removing the cap 120 from the closure portion 60 following submersion in liquid nitrogen) using a simultaneous torque of less than or equal to about 0.08 Nm and axial force of less than or equal to about 26.5 N.

It will be appreciated that the nominal outer diameter of the closure portion 60 may or may not be larger than the nominal inner diameter of the cap 120 (e.g., the lumen 132 of the cap 120) along the entire length of the closure portion 60, and the nominal outer diameter of the closure portion 60 and the nominal inner diameter of the cap 120 each may be varied along the respective length of the closure portion 60 and the cap 120, without departing from the scope of the present invention. The configuration (e.g., length, size, shape) of the interference fit area between the closure portion 60 and the cap 120 (e.g., the contact area where the nominal outer diameter of the closure portion 60 is larger than the nominal inner diameter of the cap 120), the overlapping area between the closure portion 60 and the cap 120 (e.g., the area where the closure portion 60 is disposed within the lumen 132 of the cap 120), and the textured surface(s) 205 on the outer surface 204 of the closure portion 60 and/or on the inner surface 202 of the cap 120 each may be varied, as desired and/or needed, without departing from the scope of the present invention, as long as when the specimen portion 70 is fully inserted within the lumen 132 of the cap 120, the cap 120 and the closure portion 60 creates a sealing therebetween as desired and/or needed.

In some embodiments, a distal end 67 of the closure portion 60 is the same cross-sectional geometry as the specimen portion at the position where the two portions transition. In other embodiments, the closure portion 60 has a cross-sectional geometry that is larger than a cross-sectional geometry of the specimen portion in at least one aspect (e.g. thickness, width, or the like), with a step change in dimensions therebetween (including any nominal filets or curved transitions that are inherent in the manufacturing process). The specimen portion 70 and the closure portion 60 may have the same cross-sectional shape proximate to the transition between the two (as discussed above, in some embodiments with differing dimensions) or the specimen portion 70 and the closure portion 60 may be differing cross-sectional shapes proximate to the transition between the two.

In the embodiment depicted in FIGS. 4-5, the closure portion 60 has a generally conical profile along its length, with a constant change of diameter along its length. In an exemplary embodiment, the distal end 67 has a diameter of about 1.97 mm, and the diameter of the closure portion 60 increases at an angle ranging from between about 1.13 degrees and about 1.17 degrees (e.g., preferably about 1.15 degrees) along its length. Although the angle of the taper on the closure portion 60 at any location along the length of the closure portion 60 may be varied, as desired and/or needed, without departing from the scope of the present invention, a relatively gentle taper on the closure portion 60 is advantageous. Having a significantly higher angle on the taper of the closure portion 60 may shorten the taper, reduce the surface area available for mating with the cap 120, and/or potentially impact the cap sealing capability. As such, in at least some embodiments, the angle of taper along the closure portion is not the same as the angle of taper along the cap.

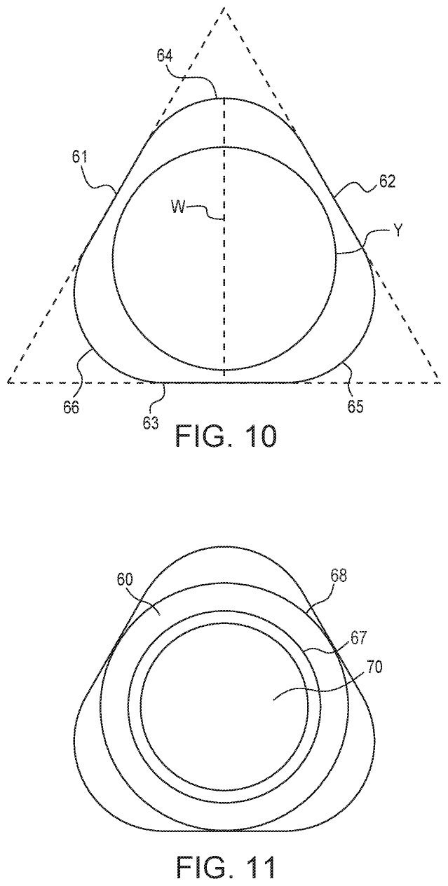

The handle portion 50 extends proximally from a proximal end 68 of the closure portion 60. The handle portion may be elongate and may include an information portion 52 and one or more ergonomic features. The handle portion 50 may have a modified triangular cross-section along its length, as shown in FIG. 10. In some embodiments, the handle portion 50 includes three planar side portions 61, 62, 63. In some embodiments, the neighboring planar side portions (e.g. 61/62, 62/63, 63/61) form an edge therebetween to form a conventional triangular cross-section (depicted by the dotted lines forming a triangle in FIG. 10).

In other embodiments, the neighboring planar side portions may transition between each other with arcuate portions 64, 65, 66 instead of extending toward each other at an edge. In some embodiments, the arcuate portions 64, 65, 66 may extend from the respective planar side portions continuously. In some embodiments, the largest diameter of the handle portion 50, i.e. from the top of one of the arcuate portions to the opposite planar side portion (line W in FIG. 10) may be about 3.39 mm. In some embodiments, the portions of the handle portion 50 that include a modified triangular cross-section may define an equilateral triangle (with arcuate portions instead of extending to points/edges of an actual equilateral triangle), such that a 60 degree angle is formed between each neighboring planar side portion 61, 62, 63. In this embodiment, the handle portions of six different devices can be positioned within a cylindrical opening of a cryocontainer 800 (such as a sleeve within a cryocontainer), as depicted in FIG. 7 (the handle portion 50 of each device being represented as Z1, Z2, etc.) with a curved portion of each device 10 pointed toward each other. In a representative embodiment, the handle portion 50 may be sized such that six devices 10 can be simultaneously positioned within a sleeve within a cryocontainer 800 that is 9 mm in diameter.

The handle portion 50 may include one or more information portions 52. The information portion 52 is configured to receive identification information regarding the biological sample that is disposed upon the scooped portion 80 of the specimen portion 70, so that the device 10, when stored in a cryocontainer with a plurality of devices, can be identified when desired. The information portion may be a recessed portion that includes a smaller outer diameter than a remainder of the handle portion 50 such that when a label is affixed to the information portion (which provides information related to the biological specimen (bar code, QR code, written information, color coding or the like) the overall cross-section of the information portion 52 (e.g., with the label affixed thereto) will be less than or equal to the cross-section of the remaining portions of the handle portion. As shown in FIG. 1, the information portion 52 may be disposed between two portions of the handle portion 50 with modified triangular profiles, as discussed above. In some embodiments, a surface of the information portion 52 is textured.

In some embodiments, the handle portion 50 may include one or more ergonomic features 53 such as one or more diameter transitions, one or more slots, a roughened surface finish, or the like in order to assist the user with manipulating the handle portion 50 and the elongate body 40 to position the elongate body 40 as desired or to insert the specimen portion 70 into the lumen 132 of the cap 120.

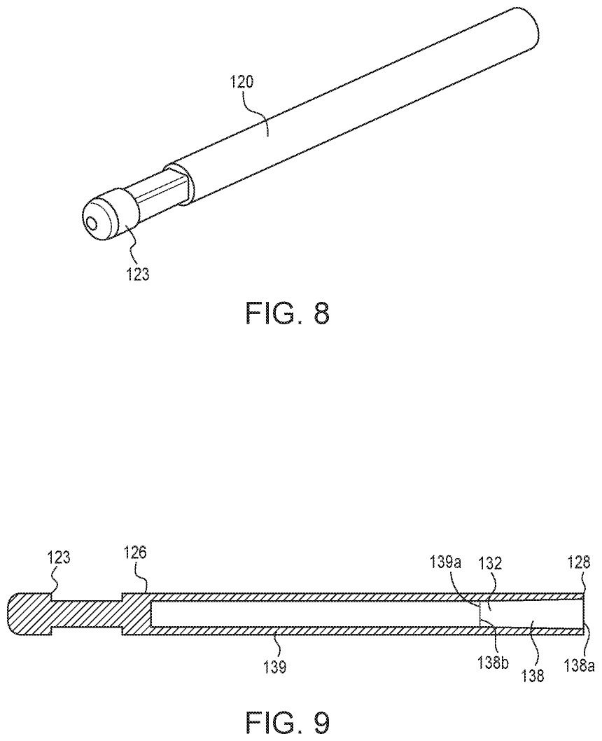

Turning now to FIGS. 8-9, the cap 120 is provided. The cap 120 includes an open proximal end 128 and closed end 126. The lumen 132 extends from the open proximal end 128 and extends blindly therealong toward the closed end 126. The end portion of the closed end 126 may include an ergonomic feature 123, such as one or more diameter transitions, one or more slots, a roughened surface finish, or the like in order to assist the user with manipulating the closed end 126 of the cap 120 in order to move the cap with respect to the specimen portion 70 of the elongate body 40 to allow the cap 120 to cover the specimen portion 70.

In some embodiments, the lumen 132 may be a single inner diameter along its length. In this embodiment, the inner diameter of the lumen 132 may be the same as the diameter of the closure portion 60 of the elongate body 40 at a position where the elongate body 40, and specifically the specimen portion 70 is fully inserted within the lumen 132 of the cap 120 such that the closure portion 60 and the cap 120 make surface to surface contact. In other embodiments, the diameter of the lumen 132 may be slightly smaller than the smallest diameter of the closure portion 60 (i.e. the diameter at the distal end 67 of the closure portion 60 in embodiments where the diameter of the closure portion 60 increases proximally along the closure portion 60), such that the closure portion 60 makes surface to surface contact with the lumen 132 for the entire length of the overlap between the cap 120 and the closure portion 60.

In other embodiments, the lumen 132 of the cap 120 may have one or more portions with varying diameter along its length. For example, as shown in FIG. 9, the lumen 132 has a proximal portion 138 and a distal portion 139, with the distal portion 139 positioned at the distal tip of the cap 120. In some embodiments, the proximal portion 138 may have a varying diameter along its length. In an exemplary embodiment, the proximal end 138a of the proximal portion 138 of the lumen may have a diameter that is larger than both the largest diameter of the specimen portion and the diameter of the closure portion 60—at least at the distal end 67 of the closure portion 60. In the exemplary embodiment disclosed herein where the diameter of the distal end 67 of the closure portion 60 is about 1.97 mm, the diameter of the proximal end 138a of the proximal portion 138 of the lumen may be about 2.1 mm, to allow some play to the user in inserting the distal tip 79 of the specimen portion 70 into the lumen 132 of the cap 120.

In some embodiments, the diameter of the lumen 132 along the proximal portion 138 decreases distally along its length, such as at an angle of about 1 degree. In the representative embodiment disclosed herein the distal end 138b of the proximal portion may have an inner diameter that is about 1.82 mm. In some embodiments, the distal end 138b of the proximal portion 138 may be the same diameter as the proximal end 139a of the distal portion 139 of the lumen. In some embodiments, the length of the proximal portion 138 may be slightly longer than the length of the closure portion 60, such as about 7.00 mm for the proximal portion 138 and about 6.5 mm for the closure portion 60.

In some embodiments, the taper of the proximal portion 138 (e.g., about the first 7 mm from the cap opening) of the lumen 132 may be about zero degree, and the taper of the remaining portion (e.g., the distal portion 139) of the lumen 132 may range between about 0.1 degree and about 0.5 degree (e.g., preferably about 0.3 degree). Although the angle of the taper on the lumen 132 of the cap 120 at any location along the length of the lumen 132 may be varied, as desired and/or needed, without departing from the scope of the present invention, it is advantageous to have a gradual angle, especially at the cap opening for keeping the mating forces low but being able to create a good seal. For the remainder of the lumen 132 (e.g., the distal portion 139; beyond about the first 7 mm from the cap opening), having a gradual angle is advantageous for manufacturability, as the lumen 132 of the cap 102 needs to be as large as possible for receiving the specimen portion 70 of the device, while the slight angle allows for easier removal of some tools/accessories during molding (such as a mandrel, core pin, or other structure, by way of non-limiting example), than having no angle.

In some embodiments, the outer diameter of the cap 120 may be smaller than the largest diameter of the elongate body 40, or in other embodiments, the outer diameter of the cap 120 may be such that the cross-section of the cap can be inscribed within the cross-section of the largest portion of the elongate body 40, which may be the handle portion 50, as shown schematically with circle Y in FIG. 10. This relative geometry ensures that when a plurality of devices 10 are positioned within the same sleeve within a cryocontainer—such as in FIG. 7, space exists between the caps 120 of neighboring devices to allow coolant, such as liquid nitrogen, to flow between the caps 120 of neighboring devices 10 to ensure uniform cooling.

The subject matter of the disclosure may also relate, among others, to the following aspects:

A first aspect relates to a sealable container for preservation of a biological sample, comprising: a cap comprising a proximal open end and a distal end with a lumen extending from the proximal open end to the distal end; and an elongate body that extends from a handle portion to a specimen portion, wherein the specimen portion is configured to receive a biological sample thereon, the elongate body further comprising a closure portion disposed between the handle portion and the specimen portion, wherein the closure portion is configured to make surface to surface contact with the cap when the specimen portion of the elongate body is fully inserted within the lumen of the cap, wherein at least one of an inner surface of the cap that will contact the closure portion when engaged thereto and an outer surface of the closure portion that will contact the cap when engaged thereto includes a textured area with a textured surface finish.

A second aspect relates to the sealable container of aspect 1, wherein an outer surface of the closure portion includes the textured area.

A third aspect relates to the sealable container of any preceding aspect, wherein the textured area covers an entire inner surface of the cap, an entire outer surface of the closure portion, or both.

A fourth aspect relates to the sealable container of any preceding aspect, wherein the textured area covers a portion of the inner surface of the cap, or a portion of the outer surface of the closure portion.

A fifth aspect relates to the sealable container of any preceding aspect, wherein the textured area extends around at least a portion of a circumference of the outer surface of the closure portion or around at least a portion of a circumference of the inner surface of the cap.

A sixth aspect relates to the sealable container of any preceding aspect, wherein an average surface roughness (Ra value) of the textured area ranges from about 1 pin to about 28 pin.

A seventh aspect relates to the sealable container of any preceding aspect, wherein an average surface roughness (Ra value) of the textured area on the inner surface of the cap ranges from about 4 pin to about 5 pin, and wherein an average surface roughness (Ra value) of the textured area on the outer surface of the closure portion ranges from about 25 pin to about 28 pin.

An eighth aspect relates to the sealable container of any preceding aspect, wherein an average surface roughness (Ra value) of the textured area ranges from about 4 pin to about 5 pin.

A ninth aspect relates to the sealable container of any preceding aspect, wherein the textured area on the inner surface of the cap extends along a length to a position at about 3 mm to about 10 mm from an edge of the proximal open end of the cap.

A tenth aspect relates to the sealable container of any preceding aspect, wherein at least one of the cap and the elongate body is made from material comprising a styrene-acrylic co-polymer.

An eleventh aspect relates to a sealable container for preservation of a biological sample, comprising: a cap comprising a proximal open end and a distal end with a lumen extending from the proximal open end to the distal end; and an elongate body that extends from a handle portion to a specimen portion, wherein the specimen portion is configured to receive a biological sample thereon, the elongate body further comprising a closure portion disposed between the handle portion and the specimen portion, wherein the closure portion is configured to make surface to surface contact with the cap when the specimen portion of the elongate body is fully inserted within the lumen of the cap, wherein an inner surface of the cap that will contact the closure portion when engaged thereto and an outer surface of the closure portion that will contact the cap when engaged thereto each include a textured area with a textured surface finish.

A twelfth aspect relates to the sealable container of aspect 11, wherein an average surface roughness (Ra value) of the textured area on the inner surface of the cap ranges from about 4 pin to about 5 pin, and wherein an average surface roughness (Ra value) of the textured area on the outer surface of the closure portion ranges from about 25 pin to about 28 pin.

A thirteenth aspect relates to the sealable container of any one of aspects 11 or 12, wherein the textured area on the outer surface of the closure portion or on the inner surface of the cap is greater than an area of contact between the closure portion and the cap.

A fourteenth aspect relates to the sealable container of any one of aspects 11 to 13, wherein the textured area covers at least a portion of the inner surface of the cap, or at least a portion of the outer surface of the closure portion.

A fifteenth aspect relates to the sealable container of any one of aspects 11 to 14, wherein the closure portion and the cap forms an interference fit therebetween due to a difference between an outer diameter of the closure portion and an inner diameter of the cap.

A sixteenth aspect relates to a sealable container for preservation of a biological sample, comprising: a cap comprising a proximal open end and a distal end with a lumen extending from the proximal open end to the distal end; and an elongate body that extends from a handle portion to a specimen portion, wherein the specimen portion is configured to receive a biological sample thereon, the elongate body further comprising a closure portion disposed between the handle portion and the specimen portion, wherein the closure portion is configured to make surface to surface contact with the cap when the specimen portion of the elongate body is fully inserted within the lumen of the cap, wherein an outer surface of the closure portion that will contact the cap when engaged thereto includes a textured area with a textured surface finish.

A seventeenth aspect relates to the sealable container of aspect 16, wherein at least a portion of the closure portion tapers at an angle of about 1.15 degrees, and at least a portion of the lumen of the cap is free from a taper.

An eighteenth aspect relates to the sealable container of any one of aspects 16 or 17, wherein the textured area on the outer surface of the closure portion is greater than or substantially equal to an area of contact between the closure portion and the cap.

A nineteenth aspect relates to the sealable container of any one of aspects 16 to 18, wherein an average surface roughness (Ra value) of the textured area ranges from about 1 pin to about 28 pin.

A twentieth aspect relates to the sealable container of any one of aspects 16 to 19, wherein a proximal portion of the lumen of the cap is free from a taper, and a distal portion of the lumen of the cap tapers at an angle of about 0.3 degree.

In addition to the features mentioned in each of the independent aspects enumerated above, some examples may show, alone or in combination, the optional features mentioned in the dependent aspects and/or as disclosed in the description above and shown in the figures.

While the preferred embodiments of the disclosure have been described, it should be understood that the disclosure is not so limited and modifications may be made without departing from the disclosure. The scope of the invention is defined by the appended claims, and all devices that come within the meaning of the claims, either literally or by equivalence, are intended to be embraced therein.

1. A sealable container for preservation of a biological sample, comprising:
a cap comprising a proximal open end and a distal end with a lumen extending from the proximal open end to the distal end; and
an elongate body that extends from a handle portion to a specimen portion, wherein the specimen portion is configured to receive a biological sample thereon, the elongate body further comprising a closure portion disposed between the handle portion and the specimen portion, wherein the closure portion is configured to make surface to surface contact with the cap when the specimen portion of the elongate body is fully inserted within the lumen of the cap,
wherein at least one of an inner surface of the cap that will contact the closure portion when engaged thereto and an outer surface of the closure portion that will contact the cap when engaged thereto includes a textured area with a textured surface finish.

2. The sealable container of claim 1, wherein an outer surface of the closure portion includes the textured area.

3. The sealable container of claim 1, wherein the textured area covers an entire inner surface of the cap, an entire outer surface of the closure portion, or both.

4. The sealable container of claim 1, wherein the textured area covers a portion of the inner surface of the cap, or a portion of the outer surface of the closure portion.

5. The sealable container of claim 1, wherein the textured area extends around at least a portion of a circumference of the outer surface of the closure portion or around at least a portion of a circumference of the inner surface of the cap.

6. The sealable container of claim 1, wherein an average surface roughness (Ra value) of the textured area ranges from about 1 pin to about 28 pin.

7. The sealable container of claim 1, wherein an average surface roughness (Ra value) of the textured area on the inner surface of the cap ranges from about 4 pin to about 5 pin, and wherein an average surface roughness (Ra value) of the textured area on the outer surface of the closure portion ranges from about 25 pin to about 28 pin.

8. The sealable container of claim 1, wherein an average surface roughness (Ra value) of the textured area ranges from about 4 pin to about 5 pin.

9. The sealable container of claim 1, wherein the textured area on the inner surface of the cap extends along a length to a position at about 3 mm to about 10 mm from an edge of the proximal open end of the cap.

10. The sealable container of claim 1, wherein at least one of the cap and the elongate body is made from material comprising a styrene-acrylic co-polymer.

11. (canceled)

12. A sealable container for preservation of a biological sample, comprising:
a cap comprising a proximal open end and a distal end with a lumen extending from the proximal open end to the distal end; and
an elongate body that extends from a handle portion to a specimen portion, wherein the specimen portion is configured to receive a biological sample thereon, the elongate body further comprising a closure portion disposed between the handle portion and the specimen portion, wherein the closure portion is configured to make surface to surface contact with the cap when the specimen portion of the elongate body is fully inserted within the lumen of the cap,
wherein an inner surface of the cap that will contact the closure portion when engaged thereto and an outer surface of the closure portion that will contact the cap when engaged thereto each include a textured area with a textured surface finish.

13. The sealable container of claim 12, wherein an average surface roughness (Ra value) of the textured area on the inner surface of the cap ranges from about 4 pin to about 5 pin, and wherein an average surface roughness (Ra value) of the textured area on the outer surface of the closure portion ranges from about 25 pin to about 28 pin.

14. The sealable container of claim 12, wherein the textured area on the outer surface of the closure portion or on the inner surface of the cap is greater than an area of contact between the closure portion and the cap.

15. The sealable container of claim 12, wherein the textured area covers at least a portion of the inner surface of the cap, or at least a portion of the outer surface of the closure portion.

16. The sealable container of claim 12, wherein the closure portion and the cap forms an interference fit therebetween due to a difference between an outer diameter of the closure portion and an inner diameter of the cap.

17. (canceled)

18. A sealable container for preservation of a biological sample, comprising:
a cap comprising a proximal open end and a distal end with a lumen extending from the proximal open end to the distal end; and
an elongate body that extends from a handle portion to a specimen portion, wherein the specimen portion is configured to receive a biological sample thereon, the elongate body further comprising a closure portion disposed between the handle portion and the specimen portion, wherein the closure portion is configured to make surface to surface contact with the cap when the specimen portion of the elongate body is fully inserted within the lumen of the cap,
wherein an outer surface of the closure portion that will contact the cap when engaged thereto includes a textured area with a textured surface finish.

19. The sealable container of claim 18, wherein at least a portion of the closure portion tapers at an angle of about 1.15 degrees, and at least a portion of the lumen of the cap is free from a taper.

20. The sealable container of claim 18, wherein the textured area on the outer surface of the closure portion is greater than or substantially equal to an area of contact between the closure portion and the cap.

21. The sealable container of claim 18, wherein an average surface roughness (Ra value) of the textured area ranges from about 1 pin to about 28 pin.

22. The sealable container of claim 18, wherein a proximal portion of the lumen of the cap is free from a taper, and a distal portion of the lumen of the cap tapers at an angle of about 0.3 degree.

23. (canceled)
